(19) United States
(12) Patent Application Publication
(10) Pub. No.: US 2016/0103367 A1
(43) Pub. Date: Apr. 14, 2016

(54) LIQUID CRYSTAL DISPLAY PANEL

(71) Applicant: Samsung Display Co., LTD., Yongin-City (KR)

(72) Inventors: Hyun ku AHN, Hwaseong-si (KR); Sung Yi KIM, Seongnam-si (KR); Tae min KIM, Seoul (KR); Tae hoon KIM, Suwon-si (KR)

(21) Appl. No.: 14/678,730

(22) Filed: Apr. 3, 2015

(30) Foreign Application Priority Data
Oct. 14, 2014 (KR) 10-2014-0138424

(51) Int. Cl. G02F 1/1337

(52) U.S. Cl. CPC G02F 1/133723; G02F 2001/133726

(57) ABSTRACT

Provided are liquid crystal display (LCD) panels. The LCD panel of one embodiment comprises a first substrate; a second substrate which faces the first substrate; a liquid crystal layer which is interposed between the first substrate and the second substrate; and a liquid crystal alignment layer which is interposed between the liquid crystal layer and at least one of the first substrate and the second substrate and comprises one or more electron-pair donors selected from the group consisting of alky amine, aryl amine, heterocyclic amine, furan, and thiophene.

### CLAIM OF PRIORITY

This application claims the priority from and all the benefits accruing under 35 U.S.C. §119 of Korean Patent Application No. 10-2014-0138424 filed on Oct. 14, 2014 in the Korean Intellectual Property Office (“KIPO”), the disclosure of which is incorporated herein by reference in its entirety.

### BACKGROUND

1. Field of the Invention

The present invention relates to a liquid crystal display (LCD) panel.

2. Description of the Related Art

A liquid crystal display (LCD) includes an LCD panel. The LCD panel includes a first display panel having thin-film transistors, a second display panel facing the first display panel, and a liquid crystal layer located between the first display panel and the second display panel.

Since the LCD panel is a non-luminous device, a light source for supplying light to the LCD panel is located behind the LCD panel. The transmittance of light supplied from the light source to the LCD panel is adjusted according to the arrangement of liquid crystal molecules in the liquid crystal layer.

The liquid crystal molecules are easily degraded by a direct-current (DC) voltage and have dielectric anisotropy in which a dielectric constant of the liquid crystal layer varies according to the arrangement direction of the liquid crystal molecules. Therefore, an alternating-current (AC) voltage is generally used to drive the liquid crystal molecules.

An image signal voltage input to a source electrode of a thin-film transistor starts to accumulate in the liquid crystal layer and a storage capacitor from the application of a gate pulse voltage. The accumulated voltage should be maintained until a next frame but is discharged by a certain amount due to a parasitic capacitor (Cgs) generated by the overlap of a gate electrode and the source electrode.

The DC voltage is offset by the discharged voltage (a kickback voltage or a level-shift voltage) and applied accordingly to the liquid crystal layer. The DC voltage applied to the liquid crystal layer ionizes impurities of the liquid crystal layer, thereby generating cation impurities. The cation impurities are stacked on an alignment layer having negative polarity, and anion impurities are stacked on a liquid crystal alignment layer having positive polarity.

The cation impurities reduce a voltage holding ratio (VHR) and causes afterimage.

### SUMMARY

Aspects of the present invention provide a liquid crystal display (LCD) panel having an improved voltage holding ratio (VHR) and reduced afterimage.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a liquid crystal display (LCD) panel comprising: a first substrate; a second substrate which faces the first substrate; a liquid crystal layer which is interposed between the first substrate and the second substrate; and a liquid crystal alignment layer which is interposed between the liquid crystal layer and at least one of the first substrate and the second substrate and comprises one or more electron-pair donors selected from the group consisting of alky amine, aryl amine, heterocyclic amine, furan, and thiophene.

The electron-pair donors may be one or more aryl amines selected from the group consisting of aniline, p-Toluidine, and p-Anisidine.

The electron-pair donors may be one or more heterocyclic amines selected from the group consisting of pyrrole, pyrazole, imidazole, indole, pyridine, pyridazine, pyrimidine, quinolone, thiazole, piperidine, and pyrrolidine.

The liquid crystal alignment layer may comprise an imide group.

The liquid crystal alignment layer may be a polyimide-based liquid crystal alignment layer having an electron-pair donor introduced to a side chain thereof.

The polyimide-based liquid crystal alignment layer may comprise one or more repeating units selected from the group consisting of a repeating unit of formula (1), a repeating unit of formula (2), and a repeating unit of formula (3):

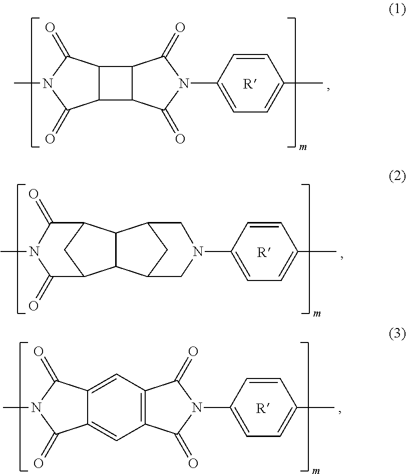

m is a natural number in a range of 1 to 300.

R′ is represented by formula (4):

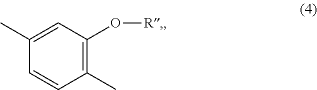

R″ is an electron-pair donor.

The polyimide-based liquid crystal alignment layer may comprise a copolymer of one or more repeating units selected from the group consisting of formulas (1) through (3) and one or more compounds selected from the group consisting of formulas (5) through (10):

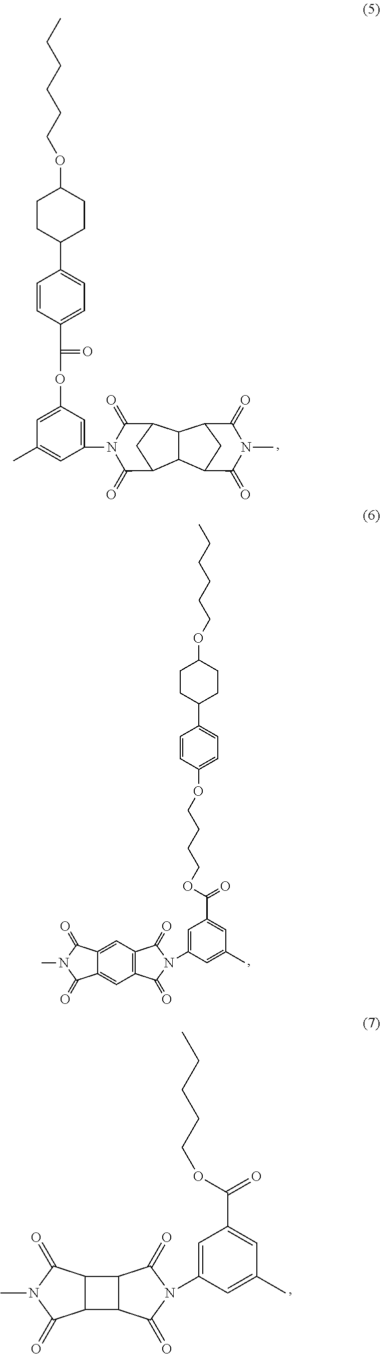

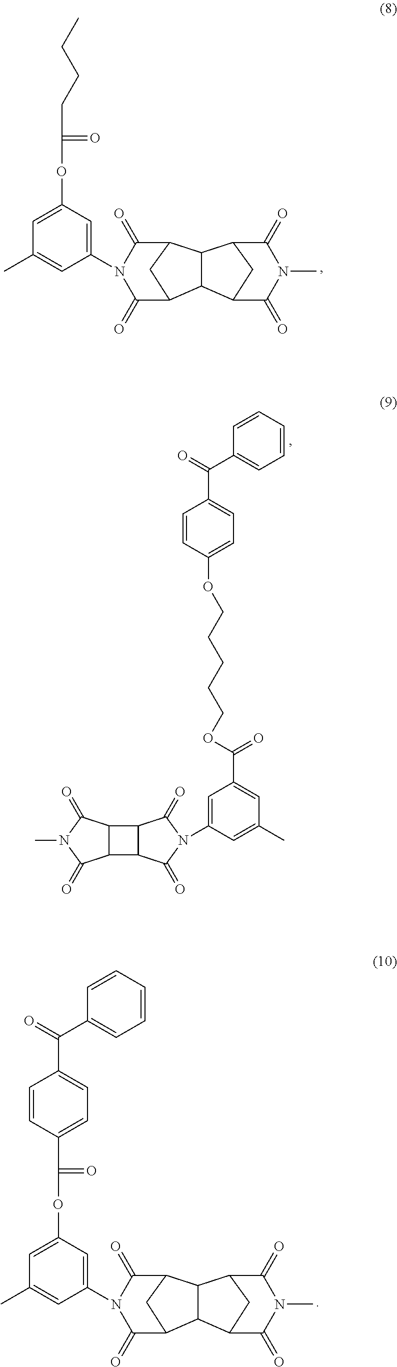

The LCD panel may further comprise a reactive mesogen layer formed on the liquid crystal alignment layer.

According to an aspect of the present invention, there is provided a LCD panel having a voltage holding ratio (VHR) of 95% or more and comprising: a first substrate;

a second substrate which faces the first substrate; a liquid crystal layer which is interposed between the first substrate and the second substrate; and a liquid crystal alignment layer which is interposed between the first substrate and the liquid crystal layer and comprises an imide group.

The VHR may be 99% or more.

Embodiments of the present invention provide at least one of the following advantages.

An LCD panel according to the present invention can have an improved VHR and reduced afterimage.

Other features and exemplary embodiments will be apparent from the following detailed description, the drawings, and the claims.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a layout view of a liquid crystal display (LCD) panel according to an embodiment of the present invention;

FIG. 2 is a cross-sectional view of the LCD panel taken along the line II-II′ of FIG. 1;

FIG. 3 is a cross-sectional view illustrating a process of forming a reactive mesogen layer of the LCD panel of FIG. 2;

FIG. 4 illustrates the result of measuring a voltage holding ratio (VHR) of the LCD panel of FIG. 1; and

FIG. 5 illustrates the result of measuring the VHR of an LCD panel according to a comparative example.

### DETAILED DESCRIPTION

Features of the inventive concept and methods of accomplishing the same may be understood more readily by reference to the following detailed description of preferred embodiments and the accompanying drawings. The inventive concept may, however, be embodied in many different forms and should not be construed as being limited to the embodiments set forth herein. Rather, these embodiments are provided so that this disclosure will be thorough and complete and will fully convey the concept of the inventive concept to those skilled in the art, and the inventive concept will only be defined by the appended claims.

In the drawings, the thickness of layers and regions are exaggerated for clarity. It will be understood that when an element or layer is referred to as being “on,” “connected to” or “coupled to” another element or layer, the element or layer can be directly on, connected or coupled to another element or layer, or one or more intervening elements or layers may be present. In contrast, when an element is referred to as being “directly on,” “directly connected to” or “directly coupled to” another element or layer, there are no intervening elements or layers present. As used herein, connected may refer to elements being physically, electrically, operably, and/or fluidly connected to each other.

Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list. Further, the use of “may” when describing embodiments of the present invention refers to “one or more embodiments of the present invention.” Also, the term “exemplary” is intended to refer to an example or illustration. As used herein, the terms “use,” “using,” and “used” may be considered synonymous with the terms “utilize,” “utilizing,” and “utilized,” respectively.

Hereinafter, embodiments of the present invention will be described with reference to the attached drawings.

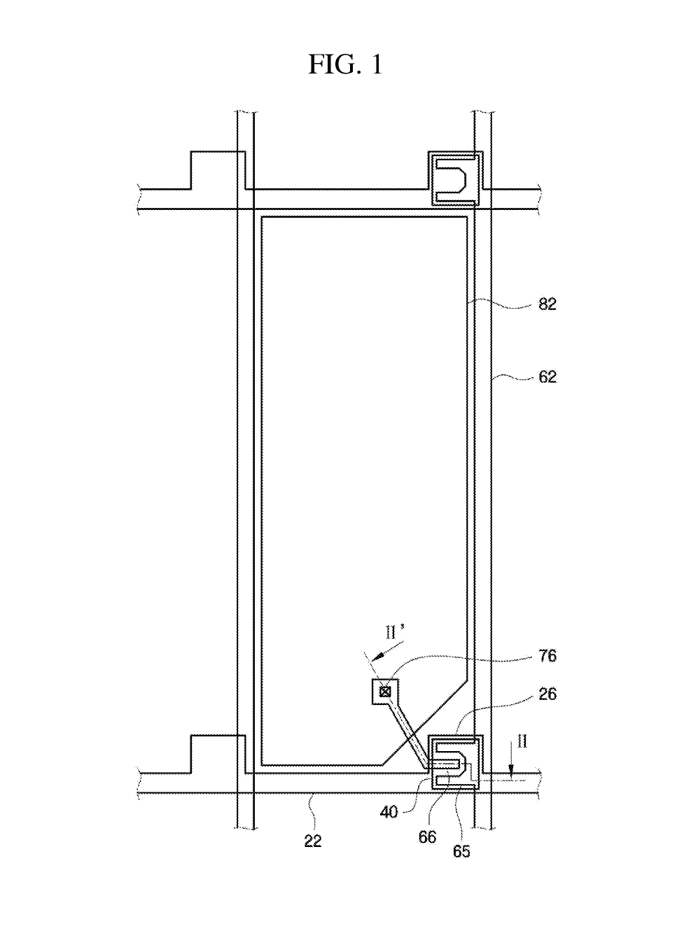

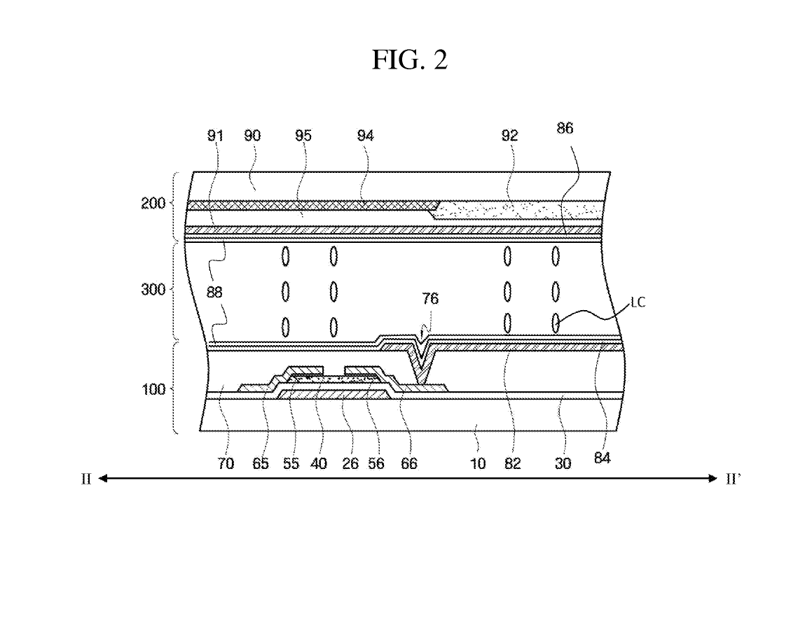

FIG. 1 is a layout view of a liquid crystal display (LCD) panel according to an embodiment of the present invention. FIG. 2 is a cross-sectional view of the LCD panel taken along the line II-II′ of FIG. 1.

Referring to FIGS. 1 and 2, a lower display panel 100 may include a first transparent insulating substrate 10, a thin-film transistor (26, 30, 40, 55, 56, 65 and 66), a passivation layer 70, a pixel electrode 82, a first liquid crystal alignment layer 84, and a reactive mesogen (RM) layer 88. The upper display panel 200 may include a second transparent insulating substrate 90, a black matrix 94, color filters 92, an overcoat layer 95, a common electrode 91, a second liquid crystal alignment layer 86, and a reactive mesogen layer 88. A liquid crystal layer 300 may be formed between the lower display panel 100 and the upper display panel 200. The liquid crystal layer 300 may include liquid crystal molecules (LC).

Each of the first insulating substrate 10 and the second insulating substrate 90 may be a transparent glass substrate made of soda lime glass or borosilicate glass or a transparent plastic substrate made of polyethersulfone or polycarbonate. In addition, the first insulating substrate 10 may be, e.g., a flexible substrate made of polyimide.

Gate wiring (22 and 26) and data wiring (62, 65 and 66) may be formed on the first insulating substrate 10.

The gate wiring (22 and 26) includes a gate line 22 and a gate electrode 26. The gate electrode 26 protrudes from the gate line 22. The gate wiring (22 and 26) delivers a gate signal or a gate voltage.

The gate wiring (22 and 26) may be made of aluminum (Al)-based metal such as aluminum and an aluminum alloy, silver (Ag)-based metal such as silver and a silver alloy, copper (Cu)-based metal such as copper and a copper alloy, molybdenum (Mo)-based metal such as molybdenum and a molybdenum alloy, chrome (Cr), titanium (Ti) or tantalum (Ta).

In addition, the gate wiring (22 and 26) may have a multilayer structure composed of two conductive layers (not illustrated) with different physical characteristics.

One of the two conductive layers may be made of metal with low resistivity, such as aluminum-based metal, silver-based metal or copper-based metal, in order to reduce a signal delay or a voltage drop of the gate wiring (22 and 26). The other one of the conductive layers may be made of a different material, in particular, a material having superior contact characteristics with indium tin oxide (ITO) and indium zinc oxide (IZO), such as molybdenum-based metal, chrome, titanium, or tantalum.

Examples of the multilayer structure include a chrome lower layer and an aluminum upper layer and an aluminum lower layer and a molybdenum upper layer. However, the present invention is not limited thereto, and the gate wiring (22 and 26) may be made of various metals and conductors.

The data wiring (62, 65 and 66) includes a data line 62, a source electrode 65, and a drain electrode 66. The data wiring (62, 65 and 66) delivers a data signal or a data voltage.

The data wiring (62, 65 and 66) may be made of chrome, molybdenum-based metal, or refractory metal such as tantalum and titanium. The data wiring (62, 65 and 66) may have a multilayer structure composed of a lower layer (not illustrated) which is made of refractory metal and an upper layer (not illustrated) which is made of a material with low resistivity and disposed on the lower layer.

Examples of the multilayer structure include a double-layer structure composed of a chrome lower layer and an aluminum upper layer or an aluminum lower layer and a molybdenum upper layer and a triple-layer structure composed of molybdenum-aluminum-molybdenum layers.

Referring to FIG. 1, the gate line 22 extends in a horizontal direction, and the data line 62 extends in a vertical direction. The gate line 22 and the data line 62 intersect each other.

The pixel electrode 82 is formed in an area surrounded by the gate line 22 and the data line 62 that intersect each other. The pixel electrode 82 may contact the drain electrode 66 through a contact hole 76. One gate line 22 may be allocated to one pixel.

A gate insulating layer 30 made of silicon nitride (SiNx) may be formed on the gate wiring (22 and 26).

A semiconductor layer 40 may be formed on the gate insulating layer 30. The semiconductor layer 40 may be made of hydrogenated amorphous silicon or polycrystalline silicon.

Ohmic contact layers 55 and 56 may be formed on the semiconductor layer 40. The ohmic contact layers 55 and 56 may be made of a material such as silicide or n+hydrogenated amorphous silicon heavily doped with n-type impurities. The ohmic contact layers 55 and 56 are disposed between the semiconductor layer 40 thereunder and the source electrode 65 and the drain electrode 66 thereon and reduce contact resistance between them. The ohmic contact layers 55 and 56 may be located on the semiconductor layer 40 to be separated from each other, and the semiconductor layer 40 may be partially exposed between the ohmic contact layers 55 and 56.

The source electrode 65 and the drain electrode 66 may be formed on the ohmic contact layers 55 and 56 and the gate insulating layer 30.

The source electrode 65 overlaps at least part of the semiconductor layer 40, and the drain electrode 66 faces the source electrode 65 with respect to the gate electrode 26 and overlaps at least part of the semiconductor layer 40. In other words, the source electrode 65 and the drain electrode 66 are separated from each other, and a portion of the semiconductor layer 40 is exposed between the source electrode 65 and the drain electrode 66.

The passivation layer 70 is formed on the data wiring (62, 65 and 66) and the exposed portion of the semiconductor layer 40.

The passivation layer 70 may be made of inorganic matter such as silicon nitride or silicon oxide, organic matter having photosensitivity and superior planarization characteristics, or a low-k insulating material (such as a-Si:C:O or a-Si:O:F) formed by plasma enhanced chemical vapor deposition (PECVD).

In addition, the passivation layer 70 may have a double-layer structure composed of a lower inorganic layer and an upper organic layer in order to protect the exposed portion of the semiconductor layer 40 while taking advantage of the superior characteristics of the organic layer. Further, the passivation layer 70 may be a red, green or blue color filter layer.

The contact hole 76 is formed in the passivation layer 70. The pixel electrode 82 is physically and electrically connected to the drain electrode 66 by the contact hole 76. Accordingly, the pixel electrode 82 receives a data voltage and a control voltage from the drain electrode 66.

The pixel electrode 82 to which a data voltage has been applied generates an electric field together with the common electrode 91 of the upper display panel 200, thereby determining the arrangement of the liquid crystals molecules between the common electrode 91 and the pixel electrode 82.

The first liquid crystal layer 84 which can align the liquid crystal layer 300 is coated on the pixel electrode 82 and the passivation layer 70. The first liquid crystal alignment layer 84 will be described later.

The reactive mesogen layer 88 is formed on the first liquid crystal alignment layer 84. The reactive mesogen layer 88 will be described later.

The black matrix 94 is formed on the second insulating substrate 90 to prevent the leakage of light and define a pixel area. The black matrix 94 may be formed in portions corresponding to the gate line 22 and the data line 62 and a portion corresponding to the thin-film transistor. The black matrix 94 may have various shapes in order to prevent the leakage of light in an area around the pixel electrode 82 and the thin-film transistor.

The black matrix 94 may be made of metal (metal oxide), such as chrome or chrome oxide, or organic black resist.

The red, green and blue color filters 92 may be arranged sequentially in the pixel area defined by the black matrix 94.

The overcoat layer 95 may be formed on the color filters 92 in order to planarize a step between them.

The common electrode 91 is formed on the overcoat layer 95. The common electrode 91 is made of a transparent conductive material such as indium tin oxide (ITO) or indium zinc oxide (IZO). The common electrode 91 is placed to face the pixel electrode 82, and the liquid crystal layer 300 is interposed between the common electrode 91 and the pixel electrode 82.

The second liquid crystal layer 86 which aligns the liquid crystal molecules is formed on the common electrode 91.

The reactive mesogen layer 88 is formed on the second liquid crystal alignment layer 86. The reactive mesogen layer 88 will be described later.

The first liquid crystal alignment layer 84 and the second liquid crystal alignment layer 86 will now be described in detail.

One or more of the first liquid crystal alignment layer 84 and the second liquid crystal alignment layer 86 may include an electron-pair donor which captures cations within the liquid crystal layer 300. That is, one of the first liquid crystal alignment layer 84 and the second liquid crystal alignment layer 86 may include an electron-pair donor, and the other one may not include the electron-pair donor. Alternatively, both the first liquid crystal alignment layer 84 and the second liquid crystal alignment layer 86 may include an electro-pair donor.

The electron-pair donor may be, but is not limited to, alkyl amine; at least one aryl amine selected from the group consisting of aniline, p-Toluidine and p-Anisidine; at least one heterocyclic amine selected from the group consisting of pyrrole, pyrazole, imidazole, indole, pyridine, pyridazine, pyrimidine, quinolone, thiazole, piperidine and pyrrolidine; furan, or thiophene.

The electron-pair donor captures cation impurities originating from impurities of the liquid crystal layer 300 by providing its unshared electron pair. In so doing, the electron-pair donor can prevent the cation impurities from being stacked on surfaces of the liquid crystal alignment layers 84 and 86.

In a nonrestrictive example, one or more of the first liquid crystal alignment layer 84 and the second liquid crystal alignment layer 86 may be made of polyimide resin introduced with an electron-pair donor. Specifically, one or more of the first liquid crystal alignment layer 84 and the second liquid crystal alignment layer 86 may be made of aliphatic polyimide resin or aromatic polyimide resin introduced with an electron-pair donor.

A nonrestrictive example of a monomer of the aromatic polyimide resin may be a cyclobutane-based polyimide monomer represented by formula (1) or a bicyclo(3,3,0) octane-based polyimide monomer represented by formula (2). A nonrestrictive example of a monomer of the aromatic polyimide resin may be a benzene-based polyimide monomer represented by formula (3).

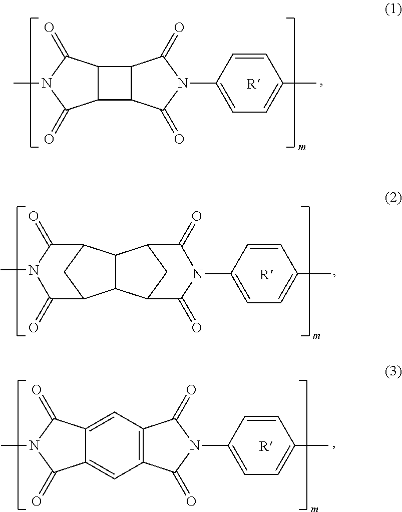

where m is a natural number in a range of 1 to 300, and R′ is a moiety, to which an electron-pair donor is introduced, and is an aromatic cyclic compound, typically, benzene. A nonrestrictive example of R′ is phenol substituted by R″ of formula (4). R″ is one of the above-described electron-pair donors.

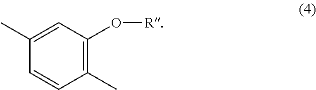

In a more specific example, one or more of the first liquid crystal alignment layer 84 and the second liquid crystal alignment layer 86 may be a copolymer of one or more of the polyimide monomers represented by formulas (1) through (3) above and one or more of polyimide monomers represented by formulas (5) through (10) below.

For example, if the first liquid crystal alignment layer 84 is made of a copolymer of one or more of the polyimide monomers represented by formulas (1) through (3) and one or more of the polyimide monomers represented by formulas (5) through (10), the second liquid crystal alignment layer 86 may be made of a copolymer of one or more of the polyimide monomers represented by formulas (1) through (3) and one or more of the polyimide monomers represented by formulas (5) through (10) or may be made of a polymer or copolymer of one or more of the polyimide monomers represented by formulas (5) through (10).

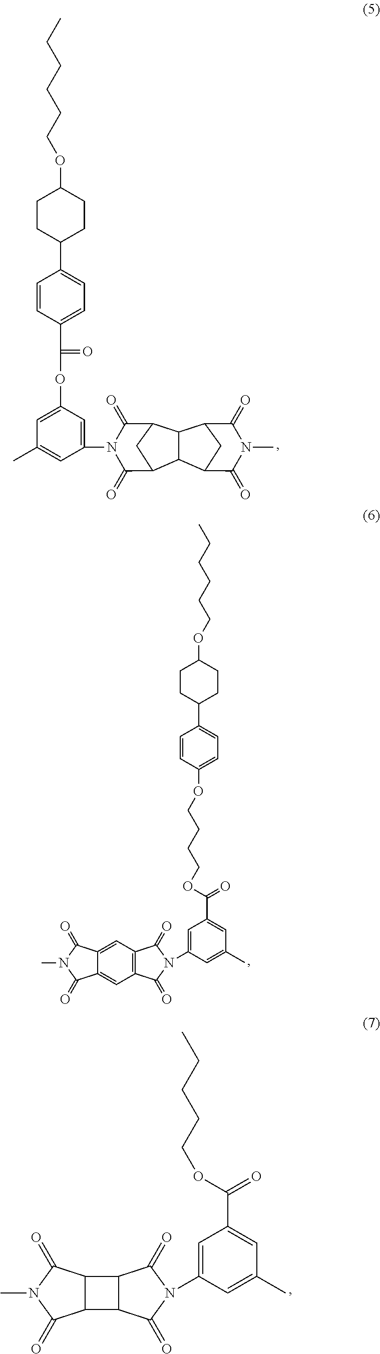

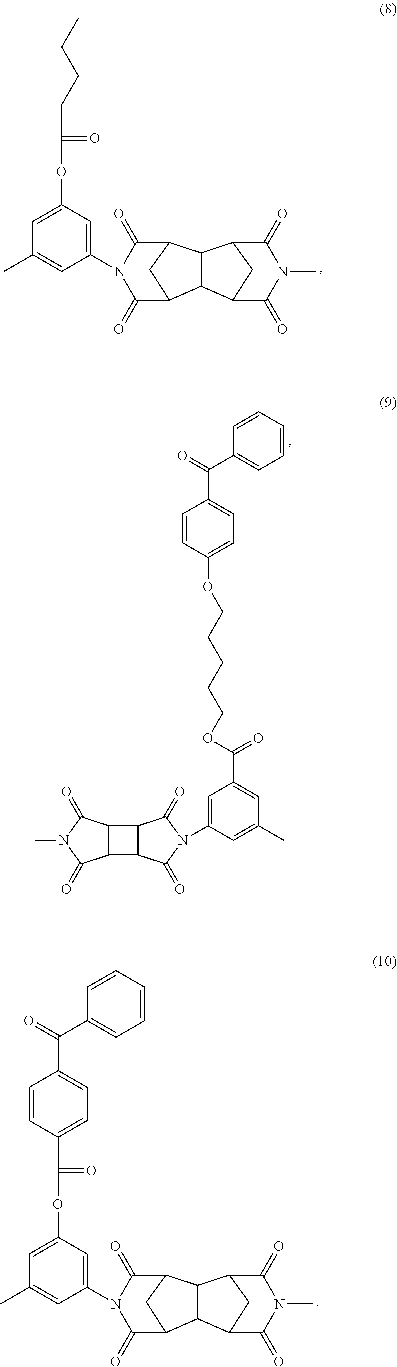

The monomer of formula (5) has a first vertical aligner bonded to a side chain of a bicyclo(3,3,0) octane-based polyimide monomer, the monomer of formula (6) has the first vertical aligner bonded to a side chain of a benzene-based polyimide monomer, the monomer of formula (7) has a second vertical aligner bonded to a side chain of a cyclobutane-based polyimide monomer, and the monomer of formula (8) has the second vertical aligner bonded to a side chain of a bicyclo(3,3,0) octane-based polyimide monomer.

The monomer of formula (9) has a first photoreactor bonded to a side chain of a cyclobutane-based monomer, and the monomer of formula (10) has a second photoreactor bonded to a side chain of a bicyclo(3,3,0) octane-based polyimide monomer.

A photoreactor may facilitate curing reaction of reactive mesogen. In a nonrestrictive example, the photoreactor may be an alkoxy group or carboxylic acid ester of diphenyl ketone as represented in formulas (9) and (10), benzyl dimethyl ketal, α-amino acetophenone and 1-hydroxy cyclohexyl phenyl keton.

A vertical aligner can align liquid crystal molecules substantially vertically to the first substrate 10 or the second substrate 90. However, vertical alignment should be understood as a concept relative to pretilt alignment.

Examples of the vertical aligner may include an alkyl group, an alkoxy group, an alicyclic compound having an alkyl group or an alkoxy group as a substituent, an aromatic cyclic compound having an alkyl group or an alkoxy group as a substituent, and chemical compounds of the same.

Nonrestrictive examples of a copolymer of the monomers of formulas (1) through (10) may be polyimide resins of formulas (11) through (13). In formulas (11) through (13), each of a, b, c, d, and e is a natural number in a range of 1 to 300.

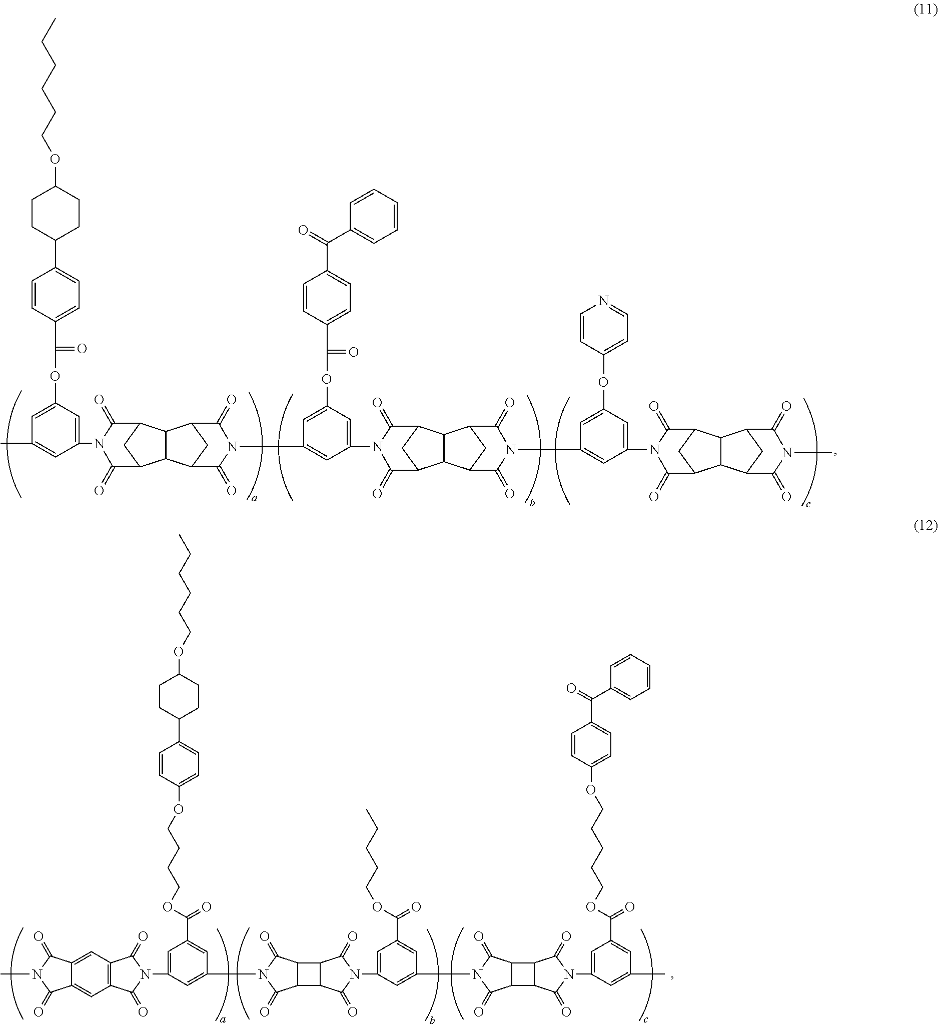

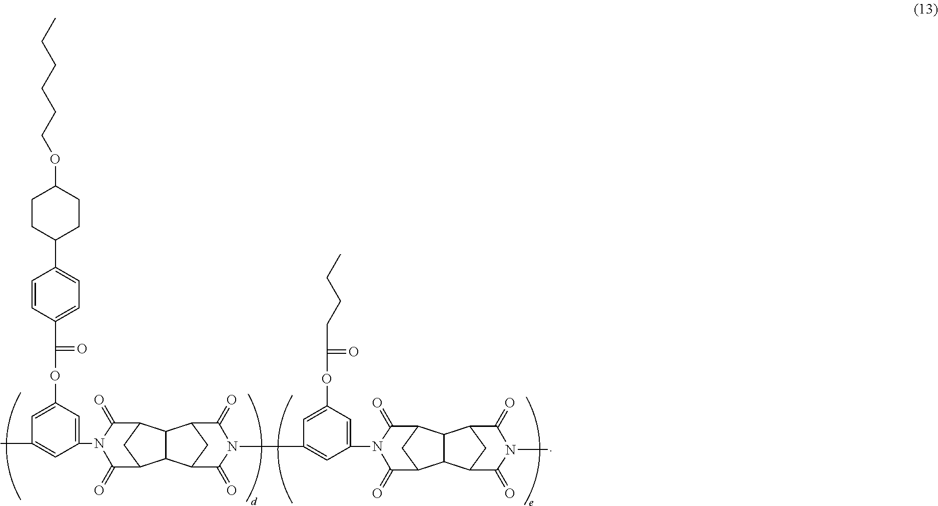

Both the first liquid crystal alignment layer 84 and the second liquid crystal alignment layer 86 may be made of the polyimide resin represented by formula (11). Alternatively, the first liquid crystal alignment layer 84 may be made of the polyimide resin represented by formula (11), and the second liquid crystal alignment layer 86 may be made of the polyimide resin represented by one of formulas (12) and (13).

More specifically, the first liquid crystal alignment layer 84 of the lower display panel 100 may be made of the polyimide resin of formula (13), and the second liquid crystal alignment layer 86 of the upper display panel 200 may be made of the polyimide resin of formula (11). Conversely, the second liquid crystal alignment layer 86 of the upper display panel 200 may be made of the polyimide resin of formula (13), and the first liquid crystal alignment layer 84 of the lower display panel 100 may be made of the polyimide resin of formula (11).

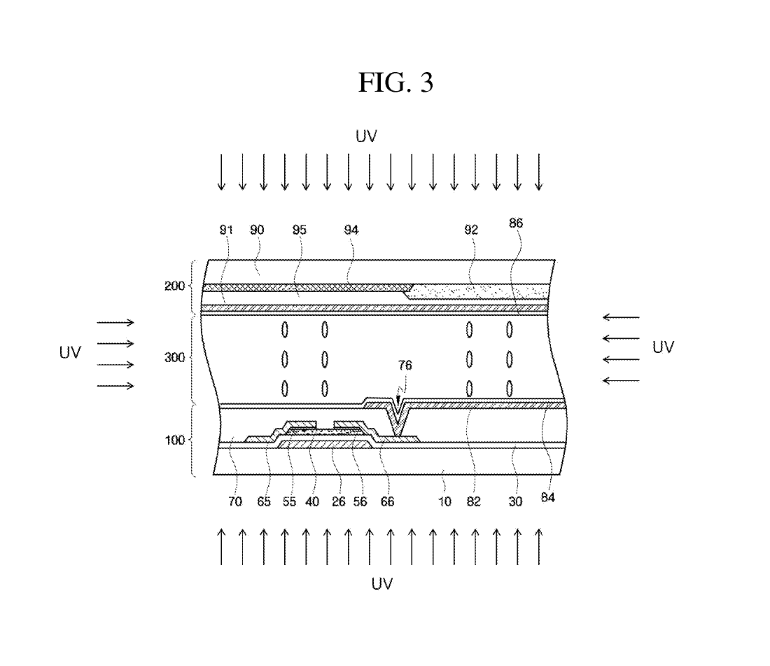

FIG. 3 is a cross-sectional view illustrating a process of forming the reactive mesogen layer 88 of the LCD panel of FIG. 2.

Reactive mesogens that form the reactive mesogen layer 88 may be added in a liquid crystal alignment composition that forms the first liquid crystal alignment layer 84 and/or the second liquid crystal alignment layer 86.

Mesogen refers to a photocrosslinkable high-molecular copolymer including a mesogen group having liquid crystal properties. Mesogen is irradiated with polarized ultraviolet (UV) light to induce the anisotropy of mesogen and then treated with heat to improve the directionality of liquid crystals (LC). The mesogen group is a polymer material exhibiting liquid crystal properties in a certain temperature range or in a solution state. Reactive mesogen may contain an aromatic cyclic compound such as biphenyl, terphenyl or naphthalene and a reactor such as acrylate, epoxy, oxetane, vinyl ether, styrene or a thiol-ene group.

The liquid crystal alignment composition having the reactive mesogens added therein is coated on the passivation layer 70 and the pixel electrode 82 of the lower display panel 100. Likewise, the liquid crystal alignment composition having the reactive mesogens added therein is coated on the common electrode 91 of the upper display panel 200. The reactive mesogens spread to the liquid crystal layer 300 in an alignment heat-treatment process performed after liquid crystals (LC) are injected between the lower display panel 100 and the upper display panel 200. In addition, the reactive mesogens react with a photoreactor of a liquid crystal alignment layer to form a pretilt in a UV light exposure process under or not under an electric field. Light exposure under an electric field may be performed in a state where a high voltage of 3 to 50 V has been applied in a direct current (DC) or alternating current (AC) state.

In the UV exposure process, the reactive mesogens bonded to the photoreactor of the liquid crystal alignment layer form the reactive mesogen layer 88 on the liquid crystal alignment layer.

Referring to FIGS. 2 and 3, after UV light is irradiated to the LCD panel of FIG. 3, the reactive mesogen layer 88 is formed on the first liquid crystal alignment layer 84 and the second liquid crystal alignment layer 86 in the LCD panel of FIG. 2.

In FIG. 3, the reactive mesogen layer 88 is formed on both the first liquid crystal alignment layer 84 and the second liquid crystal alignment layer 86. However, the reactive mesogen layer 88 may also be formed only on the first liquid crystal alignment layer 84 or the second liquid crystal alignment layer 86.

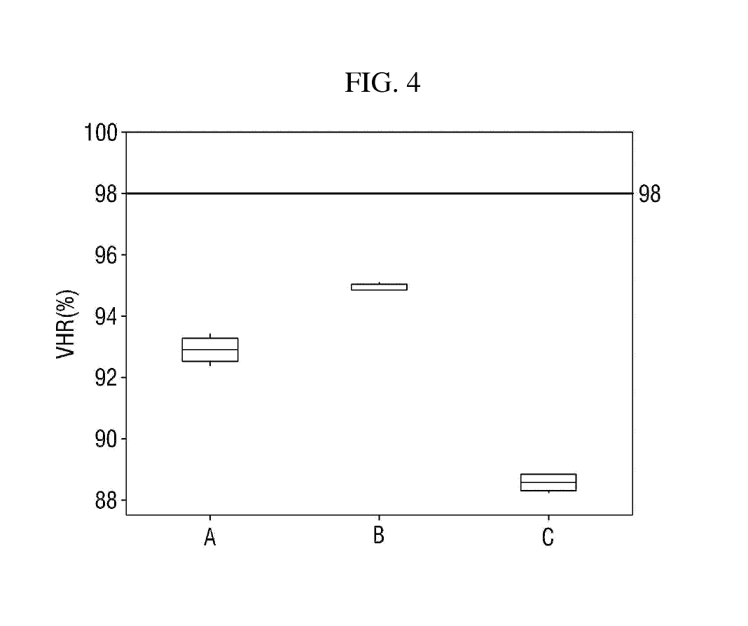

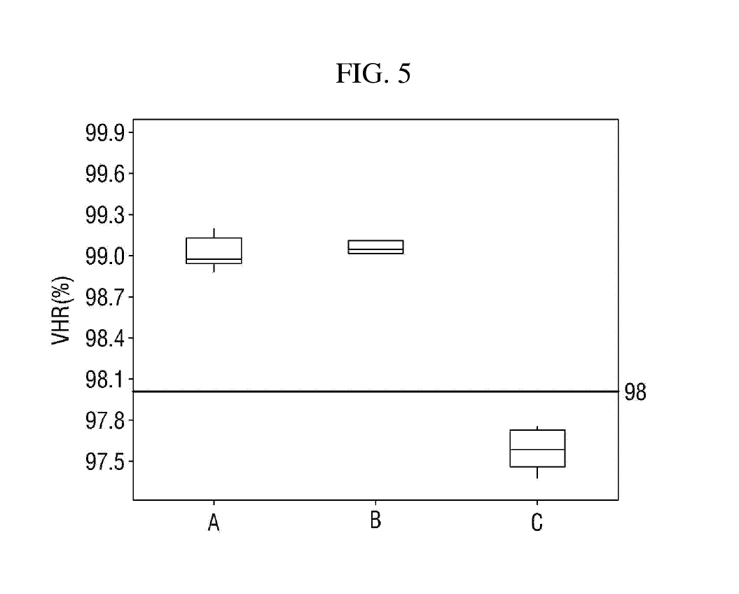

FIG. 4 illustrates the result of measuring a voltage holding ratio (VHR) of the LCD panel of FIG. 1. FIG. 5 illustrates the result of measuring the VHR of an LCD panel according to a comparative example.

An LCD panel (Embodiment 1) according to an embodiment of the present invention and an LCD panel (Comparative Example) according to a comparative example were manufactured by bonding a lower display panel 100 and an upper display panel 200 together and then injecting liquid crystals (LC1201) having negative dielectric anisotropy between the lower display panel 100 and the upper display panel 200.

In the embodiment of the present invention, a second liquid crystal alignment layer 86 of the upper display panel 200 was made of the polyimide resin of formula (11) having pyridine as an electro-pair donor, and a first liquid crystal alignment layer 84 of the lower display panel 100 was made of the polyimide resin of formula (13) without an electron-pair donor.

On the other hand, in the comparative example, a second liquid crystal alignment layer 86 was made of the polyimide resin of formula (12) without an electron-pair donor, and a first liquid crystal alignment layer 84 was made of the polyimide resin of formula (13) without an electron-pair donor.

Then, the VHRs of the embodiment and the comparative example were measured.

In FIGS. 4 and 5, ‘A’ represents a VHR before UV exposure, ‘B’ represents the VHR after UV exposure, and ‘C’ represents the VHR after fluorescent UV.

The results of FIG. 4 can be summarized as in Table 1 below.

TABLE 1

| | Embodiment 1 | | |
|---|---|---|---|
| | Before | After | After fluorescent UV |
| VHR (%) | exposure (A) | exposure (B) | exposure (C) |
| Minimum value | 98.9 | 99.0 | 97.4 |
| Maximum value | 99.2 | 99.1 | 97.8 |
| Mean | 99.0 | 99.1 | 97.6 |
| Standard deviation | 0.11 | 0.04 | 0.14 |
| Number of samples | 8 | 8 | 8 |
| (S/S) | | | |

The results of FIG. 5 can be summarized as in Table 2 below.

TABLE 2

| | Comparative example | | |
|---|---|---|---|
| | Before | After | After fluorescent UV |
| VHR (%) | exposure (A) | exposure (B) | exposure (C) |
| Minimum value | 92.4 | 94.4 | 88.2 |
| Maximum value | 93.5 | 95.1 | 88.8 |
| Mean | 92.9 | 94.9 | 88.5 |
| Standard deviation | 0.39 | 0.22 | 0.25 |
| Number of samples | 8 | 8 | 8 |
| (S/S) | | | |

Referring to FIGS. 4 and 5 and Tables 1 and 2, the embodiment has an improved VHR compared with the comparative example.

Table 3 below shows that a liquid crystal alignment layer having an electron-pair donor improves the VHR despite a change of liquid crystals. Embodiment 2 is different from Embodiment 1 in that liquid crystals (LC D8) having negative dielectric anisotropy are used.

TABLE 3

| | Embodiment 1 | | Embodiment 2 | |
|---|---|---|---|---|
| | Before | After | Before | After |
| VHR (%) | exposure (A) | exposure (B) | exposure (A) | exposure (B) |
| Minimum | 98.9 | 99.0 | 98.6 | 98.9 |
| value | | | | |
| Maximum | 99.2 | 99.1 | 99.0 | 99.1 |
| value | | | | |
| Mean | 99.0 | 99.1 | 98.9 | 99.0 |
| Standard | 0.11 | 0.04 | 0.14 | 0.06 |
| deviation | | | | |
| Number of | 8 | 8 | 8 | 8 |
| samples (S/S) | | | | |

While the invention has been particularly shown and described with reference to exemplary embodiments thereof, it will be understood by those of ordinary skill in the art that various changes in provide and detail may be made therein without departing from the spirit and scope of the invention as defined by the following claims. The exemplary embodiments should be considered in a descriptive sense only and not for purposes of limitation.

1. A liquid crystal display (LCD) panel comprising:
a first substrate;
a second substrate which faces the first substrate;
a liquid crystal layer which is interposed between the first substrate and the second substrate;
a polyimide-based liquid crystal alignment layer which is interposed between the liquid crystal layer and at least one of the first substrate and the second substrate, having reactive mesogens,
one or more side chains having a vertical aligner to align liquid crystal molecules substantially vertically to the first substrate and the second substrate,
one or more side chains having an electron-pair donor to capture impurities, and
one or more side chains having a photoreactor to initiate a polymerization of the reactive mesogens, and
a reactive mesogen layer formed on the polyimide-based liquid crystal alignment layer,
wherein the electron-pair donor is selected from the group consisting of alkyl amine, aryl amine, heterocyclic amine, furan, and thiophene, and the LCD panel having a voltage holding ratio (VHR) of 95% or more.

2. The LCD panel of claim 1, wherein the electron-pair donors are one or more aryl amines selected from the group consisting of aniline, p-Toluidine, and p-Anisidine.

3. The LCD panel of claim 1, wherein the electron-pair donors are one or more heterocyclic amines selected from the group consisting of pyrrole, pyrazole, imidazole, indole, pyridine, pyridazine, pyrimidine, quinolone, thiazole, piperidine, and pyrrolidine.

4-5. (canceled)

6. The LCD panel of claim 1, wherein the polyimide-based liquid crystal alignment layer comprises one or more repeating units selected from the group consisting of a repeating unit of formula (1), a repeating unit of formula (2), and a repeating unit of formula (3): 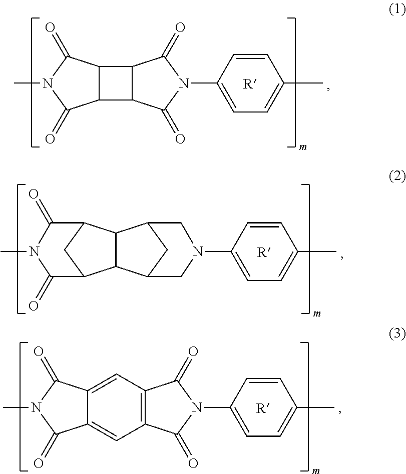
wherein m is a natural number in a range of 1 to 300, R′ is represented by formula (4): 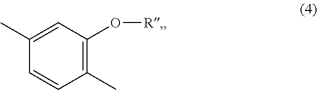
and R″ is an electron-pair donor.

7. The LCD panel of claim 6, wherein the polyimide-based liquid crystal alignment layer comprises a copolymer of one or more repeating units selected from the group consisting of formulas (1) through (3) and one or more compounds selected from the group consisting of formulas (5) through (10):

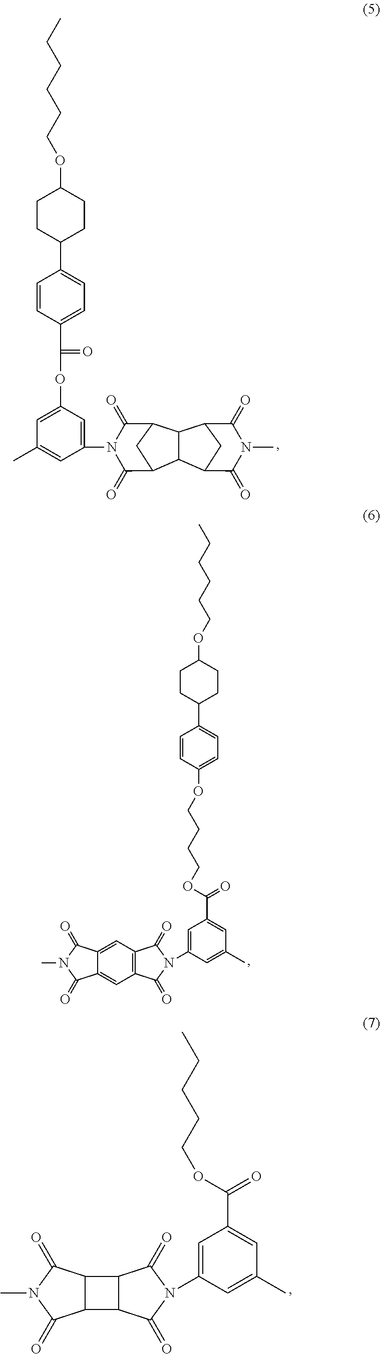

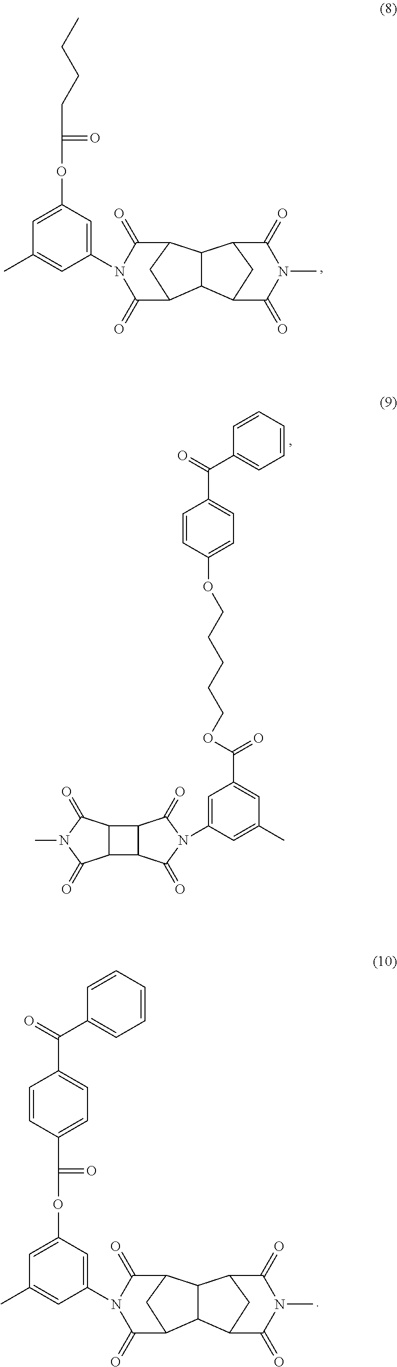

8-9. (canceled)

10. The LCD panel of claim 1, wherein the VHR is 99% or more.
